(19) United States
(12) Patent Application Publication
(10) Pub. No.: US 2024/0369471 A1
(43) Pub. Date: Nov. 7, 2024

(54) SYSTEM AND METHODS FOR TRANSILLUMINATION

(71) Applicant: 10x Genomics, Inc., Pleasanton, CA (US)

(72) Inventors: David HOFFMAN, Pleasanton, CA (US); Denis PRISTINSKI, Dublin, CA (US); Rajiv BHARADWAJ, Pleasanton, CA (US); Yiran ZHANG, Pleasanton, CA (US)

(21) Appl. No.: 18/775,876

(22) Filed: Jul. 17, 2024

Related U.S. Application Data
(63) Continuation of application No. PCT/US2023/060857, filed on Jan. 18, 2023.
(60) Provisional application No. 63/300,474, filed on Jan. 18, 2022.

(51) Int. Cl. G01N 21/03; G01N 21/05; G01N 21/47; G01N 21/64

(52) U.S. Cl. CPC G01N 21/0332; G01N 21/0303; G01N 21/05; G01N 21/6458; G01N 2021/0325; G01N 2021/0346; G01N 2021/4742; G01N 2201/0826

(57) ABSTRACT

Disclosed are assemblies, systems, and methods for transilluminating a sample disposed within a device. An assembly includes a first optically transparent substrate configured to receive a biological sample, a second optically transparent substrate having a top surface, a bottom surface, and a plurality of sides. The first substrate contacts the top surface of the second substrate. The assembly includes at least one light source configured to illuminate at least one of the plurality of sides of the second substrate and a light scattering layer on the bottom surface of the second substrate. The light scattering layer is configured to scatter light from the light source. The assembly includes a thermal control module coupled to the second substrate and configured to control the temperature of the second substrate.

### CROSS-REFERENCE TO RELATED APPLICATIONS

This application is a continuation of International Application No. PCT/US2023/060857, filed on Jan. 18, 2023, which claims priority to U.S. Provisional Patent Application No. 63/300,474, filed Jan. 18, 2022, entitled “SYSTEM FOR MONOLITHIC TRANSILLUMINATION OF A MICROFLUIDIC CHIP.” The contents of each application are herein incorporated by reference in its entirety for all purposes.

### FIELD OF THE INVENTION

The present disclosure relates generally to transillumination of a biological sample, more particularly to systems and related apparatus for transilluminating a biological sample disposed on a substrate positioned within a device while providing for thermal control of the biological sample.

### BACKGROUND

Optofluidic devices integrate optical components into a device, generally enabling imaging of fluids on the device. Optofluidic devices can be useful in studies involving biotechnology and biochemistry such as fluorescence spectroscopy, Bright-field microscopy, pseudo DIC microscopy, and imaging biological samples that utilize sample-staining methods.

Many biochemical imaging platforms utilize strict temperature control that may involve large, stable, and rapid temperature variations to run a biochemical reaction on a substrate. Temperature control can be accomplished via contact between the substrate and an operable thermal device (i.e., a heat exchanger) such as a thermal block. When thermal constraints are especially strict, uninterrupted contact between the substrate and the heat exchanger is preferred, to ensure thermal uniformity across the substrate.

In addition to temperature control, some biochemical imaging platforms also utilize illumination of the substrate, wherein the substrate is illuminated by light spread throughout the substrate. Illumination can be accomplished via cutting holes in a substrate and illuminating the substrate from below. However, it can be difficult to incorporate trans illumination in an optofluidic device when tight temperature control is required. Cutting holes in a substrate can impair the thermal contact between the substrate and the thermal block and may also add to the thermal load on the substrate. For example, if a given assay/protocol requires large, stable, and quick temperature jumps then a large thermal chuck may be required. Moreover, the performance of such a chuck can be greatly reduced if trans illumination holes have to be cut into it. Thus, cutting illumination holes may impair thermal uniformity and thermal control of the substrate and negatively impact the underlying biochemical reaction being conducted.

### SUMMARY OF THE INVENTION

Described herein are systems that enable transillumination of a biological sample disposed on a substrate while providing for thermal control of the biological sample.

According to an aspect, a system is configured such that light from a light source is coupled to one or more of the sides of a substrate thereby enabling transillumination of the substrate. In some embodiments, the system can allow thorough transillumination of the substrate by incorporating diffusers/scatterers in and/or on the surfaces of the substrate such that the diffusers/scatterers scatter light into the substrate from the light source. In some embodiments, coupling light to a substrate with a biological sample disposed thereon may not get all the emitted light to scatter upwards as light may escape through the bottom and sides of a substrate. Thus, in some embodiments, the transilluminated substrate can be used for imaging a sample located on another substrate attached to (the top surface of) the transilluminated substrate. Where the objective of imaging the sample includes strict temperature constraints, the system can allow transillumination of the substrate without sacrificing thermal contact with a heat exchanger and thus without impairing the thermal control of the system.

In some embodiments, an assembly includes a first substrate configured to receive a biological sample, wherein the first substrate is optically transparent; a second substrate having a top surface, a bottom surface, and a plurality of sides, wherein the first substrate contacts the top surface of the second substrate, wherein the second substrate is optically transparent; at least one light source configured to illuminate at least one of the plurality of sides of the second substrate; a light scattering layer on the bottom surface of the second substrate, wherein the light scattering layer is configured to scatter light from the light source; and a thermal control module coupled to the second substrate and configured to control the temperature of the second substrate. In some embodiments, the light scattering layer comprises a plurality of titanium dioxide nanoparticles disposed within a polymer. In some embodiments, the plurality of titanium dioxide nanoparticles comprises a mean diameter of less than or equal to about 500 nm. In some embodiments, the plurality of titanium nanoparticles is 30-60 wt. % of the light scattering layer. In some embodiments, the polymer comprises an epoxy resin. In some embodiments, the second substrate comprises sapphire glass. In some embodiments, the assembly includes at least one reflective layer disposed on at least one of the plurality of sides of the second substrate. In some embodiments, the at least one reflective layer comprises silver or aluminum. In some embodiments, the at least one reflective layer is disposed on at least one of the plurality of sides that is not illuminated by the at least one light source. In some embodiments, each reflective layer is opposite a side of the second substrate illuminated by the at least one light source. In some embodiments, the at least one light source is connected to at least one of the plurality of sides of the second substrate. In some embodiments, light emitted from the at least one light source is coupled by the second substrate and converted to wide angle transillumination of the sample. In some embodiments, the at least one light source comprises light emitting diodes (LEDs). In some embodiments, the at least one light source comprises a substantially uniform spectrum. In some embodiments, the at least one light source is positioned in a plane that is substantially aligned with at least one side of the plurality of sides. In some embodiments, the assembly includes a fiber optic device coupling the at least one light source to the second substrate and/or the light scattering layer. In some embodiments, the thermal control module contacts the light scattering layer opposite the second substrate.

In some embodiments, a system includes any embodiment of the assemblies disclosed herein and an imaging device configured to capture an image of the sample. In some embodiments, the imaging device is disposed on a side of the first substrate opposite the second substrate. In some embodiments, the imaging device comprises an objective lens. In some embodiments, the objective lens comprises a high numerical aperture. In some embodiments, the objective lens comprises a numerical aperture of about 1.0 or more. In some embodiments, the sample substrate comprises a glass slide.

In some embodiments, a method includes providing an assembly comprising: a first substrate configured to receive a biological sample, wherein the first substrate is optically transparent; a second substrate having a top surface, a bottom surface, and a plurality of sides, wherein the first substrate contacts the top surface of the second substrate, wherein the second substrate is optically transparent; at least one light source configured to illuminate at least one of the plurality of sides of the second substrate; a light scattering layer on the bottom surface of the second substrate, wherein the light scattering layer is configured to scatter light from the light source; and energizing the at least one light source to thereby couple emitted light from the at least one light source to the second substrate and scatter the emitted light via the light scattering layer to transilluminate the sample. In some embodiments, the assembly further comprises a thermal control module coupled to the second substrate and configured to control the temperature of the second substrate, wherein the thermal control module contacts the light scattering layer opposite the second substrate. In some embodiments, the light scattering layer comprises a plurality of titanium dioxide nanoparticles disposed within a polymer. In some embodiments, the plurality of titanium dioxide nanoparticles comprises a mean diameter of less than or equal to about 500 nm. In some embodiments, the plurality of titanium nanoparticles is 30-60 wt. % of the light scattering layer. In some embodiments, the polymer comprises an epoxy resin. In some embodiments, the second substrate comprises sapphire glass. In some embodiments, at least one reflective layer disposed on at least one of the plurality of sides of the second substrate. In some embodiments, the at least one reflective layer comprises silver or aluminum. In some embodiments, the at least one reflective layer is disposed on at least one of the plurality of sides that is not illuminated by the at least one light source. In some embodiments, each reflective layer is opposite a side of the second substrate illuminated by the at least one light source. In some embodiments, the at least one light source is connected to at least one of the plurality of sides of the second substrate. In some embodiments, light emitted from the at least one light source is coupled by the second substrate and converted to wide angle transillumination of the sample. In some embodiments, the at least one light source comprises light emitting diodes (LEDs). In some embodiments, the at least one light source comprises a substantially uniform spectrum. In some embodiments, the at least one light source is positioned in a plane that is substantially aligned with at least one side of the plurality of sides. In some embodiments, a fiber optic device coupling the at least one light source to the second substrate and/or the light scattering layer.

In some embodiments, a substrate is made by the process of providing an optically transparent substrate having a top, a bottom, and a plurality of sides, wherein the optically transparent substrate comprises sapphire glass; applying to the bottom of the optically transparent substrate a layer comprising a plurality of titanium dioxide nanoparticles and epoxy resin, wherein the plurality of titanium dioxide nanoparticles has a mean diameter of less than or equal to about 500 nm; and applying to at least one side of the plurality of sides a silver or aluminum layer.

It will be appreciated that any of the embodiments, variations, aspects, features, and options described in view of the systems, assemblies, substrates, and methods described herein can be combined.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE DRAWINGS

Exemplary embodiments are described with reference to the accompanying figures, in which:

FIG. 1 is an example workflow of analysis of a biological sample (e.g., a cell or tissue sample) using an opto-fluidic instrument, according to some embodiments disclosed herein.

FIG. 2 depicts a side view of a system with an open flow cell, according to some embodiments disclosed herein.

FIG. 3 depicts a side view of a system with a closed flow cell, in accordance with some embodiments disclosed herein.

FIG. 4A depicts a top view of a sample carrier device connected to a plurality of light guides, in accordance with some embodiments disclosed herein.

FIG. 4B depicts a top view of a sample carrier device comprising a plurality of diffusers that is connected to a plurality of light guides, in accordance with some embodiments disclosed herein.

FIG. 5 depicts a sample carrier device comprising a variety of diffusers, according to some embodiments disclosed herein.

FIG. 6 depicts a side view of a system with an open flow cell comprising an imaging device, according to some embodiments disclosed herein.

FIG. 7 depicts a side view of a system with a sample substrate, an optically transparent substrate, and a light scattering layer, according to some embodiments disclosed herein.

FIG. 8 depicts a top or bottom view of a light scattering layer, according to some embodiments disclosed herein.

In the Figures, like reference numerals refer to like components unless otherwise stated.

### DETAILED DESCRIPTION OF THE INVENTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are systems that may address one or more of the needs discussed above. Described herein are exemplary embodiments of a system for transilluminating a sample substrate/device/chip without impairing temperature control of the substrate which may address the problems and shortcomings of known systems and methods described above.

Target molecules (e.g., nucleic acids, proteins, antibodies, etc.) can be detected in biological samples (e.g., one or more cells or a tissue sample) using an instrument having integrated optics and fluidics modules (an “opto-fluidic instrument” or “opto-fluidic system”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in-situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample from a mammal. A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids needed for establishing the experimental conditions required for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The in-situ analysis system may also include other ancillary modules configured to facilitate the operation of the opto-fluidic instrument, such as, but not limited to, cooling systems, motion calibration systems, etc.

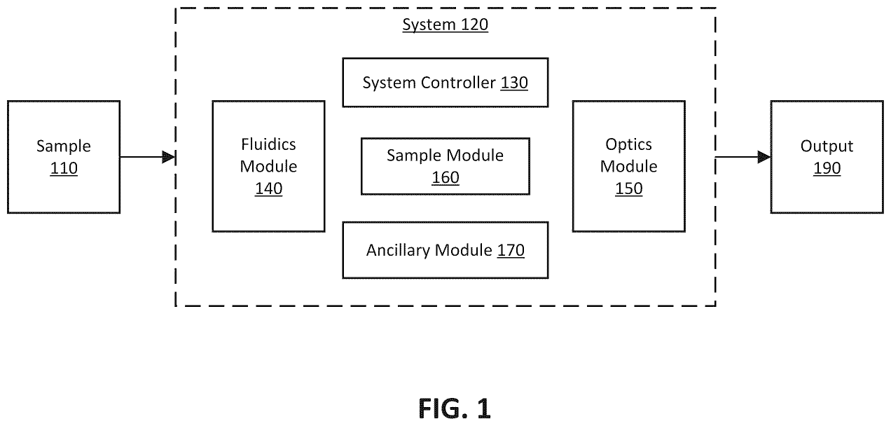

FIG. 1 shows an example workflow of analysis of a biological sample 110 (e.g., cell or tissue sample) using an opto-fluidic instrument 120, according to various embodiments. In various embodiments, the sample 110 can be a biological sample (e.g., a tissue) that includes molecules such as DNA, RNA, proteins, antibodies, etc. For example, the sample 110 can be a sectioned tissue that is treated to access the RNA thereof for labeling with circularizable DNA probes. Ligation of the probes may generate a circular DNA probe which can be enzymatically amplified and bound with fluorescent oligonucleotides, which can create bright signal that is convenient to image and has a high signal-to-noise ratio.

In various embodiments, the sample 110 may be placed in the opto-fluidic instrument 120 for analysis and detection of the molecules in the sample 110. In various embodiments, the opto-fluidic instrument 120 can be a system configured to facilitate the experimental conditions conducive for the detection of the target molecules. For example, the opto-fluidic instrument 120 can include a fluidics module 140, an optics module 150, a sample module 160, and an ancillary module 170, and these modules may be operated by a system controller 130 to create the experimental conditions for the probing of the molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components in communication with each other, or at least some of them may be integrated together.

In various embodiments, the sample module 160 may be configured to receive the sample 110 into the opto-fluidic instrument 120. For instance, the sample module 160 may include a sample interface module (SIM) that is configured to receive a sample device (e.g., cassette) onto which the sample 110 can be deposited. That is, the sample 110 may be placed in the opto-fluidic instrument 120 by depositing the sample 110 (e.g., the sectioned tissue) on a sample device that is then inserted into the SIM of the sample module 160. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along the two-dimensional (2D) plane of the opto-fluidic instrument 120.

The experimental conditions that are conducive for the detection of the molecules in the sample 110 may depend on the target molecule detection technique that is employed by the opto-fluidic instrument 120. For example, in various embodiments, the opto-fluidic instrument 120 can be a system that is configured to detect molecules in the sample 110 via hybridization of probes. In such cases, the experimental conditions can include molecule hybridization conditions that result in the intensity of hybridization of the target molecule (e.g., nucleic acid) to a probe (e.g., oligonucleotide) being significantly higher when the probe sequence is complementary to the target molecule than when there is a single-base mismatch. The hybridization conditions include the preparation of the sample 110 using reagents such as washing/stripping reagents, hybridizing reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include reservoirs configured to store the reagents, as well as a waste container configured for collecting the reagents (e.g., and other waste) after use by the opto-fluidic instrument 120 to analyze and detect the molecules of the sample 110. Further, the fluidics module 140 may also include pumps, tubes, pipettes, etc., that are configured to facilitate the transport of the reagent to the sample device (e.g., and as such the sample 110). For instance, the fluidics module 140 may include pumps (“reagent pumps”) that are configured to pump washing/stripping reagents to the sample device for use in washing/stripping the sample 110 (e.g., as well as other washing functions such as washing an objective lens of the imaging system of the optics module 150).

In various embodiments, the ancillary module 170 can be a cooling system of the opto-fluidic instrument 120, and the cooling system may include a network of coolant-carrying tubes that are configured to transport coolants to various modules of the opto-fluidic instrument 120 for regulating the temperatures thereof. In such cases, the fluidics module 140 may include coolant reservoirs for storing the coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the fluidics module 140 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the fluidics module 140 may also include cooling fans that are configured to force air (e.g., cool and/or ambient air) into the returning coolant reservoirs to cool the heated coolants stored therein. In some instance, the fluidics module 140 may also include cooling fans that are configured to force air directly into a component of the opto-fluidic instrument 120 so as to cool said component. For example, the fluidics module 140 may include cooling fans that are configured to direct cool or ambient air into the system controller 130 to cool the same.

As discussed above, the opto-fluidic instrument 120 may include an optics module 150 which include the various optical components of the opto-fluidic instrument 120, such as but not limited to a camera, an illumination module (e.g., light source such as LEDs), an objective lens, and/or the like. The optics module 150 may include a fluorescence imaging system that is configured to image the fluorescence emitted by the probes (e.g., oligonucleotides) in the sample 110 after the probes are excited by light from the illumination module of the optics module 150.

In some instances, the optics module 150 may also include an optical frame onto which the camera, the illumination module, and/or the X-Y stage of the sample module 160 may be mounted.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 may analyze the sample 110 and may generate the output 190 that includes indications of the presence of the target molecules in the sample 110. For instance, with respect to the example embodiment discussed above where the opto-fluidic instrument 120 employs a hybridization technique for detecting molecules, the opto-fluidic instrument 120 may cause the sample 110 to undergo successive rounds of fluorescent probe hybridization (using two or more sets of fluorescent probes, where each set of fluorescent probes is excited by a different color channel) and be imaged to detect target molecules in the probed sample 110. In such cases, the output 190 may include optical signatures (e.g., a codeword) specific to each gene, which allow the identification of the target molecules.

In some instances, an assembly for transilluminating a substrate can include a sample carrier device (e.g., a microfluidic chip or glass slide), a thermal control module configured to control the temperature of the sample carrier device (e.g., a thermoelectric module), and a light source configured to illuminate the sample carrier device. In some instances, the assembly includes a heat exchanger (e.g., a fluid block having a cooling fluid flowing therethrough). In some instances, an assembly for transilluminating can include sample carrier device (e.g., a sample substrate), an optically transparent substrate, a light source configured to illuminate the optically transparent substrate, a light scattering layer configured to scatter light from the light source, and/or a thermal control module configured to control the temperature of the sample carrier device and/or optically transparent substrate.

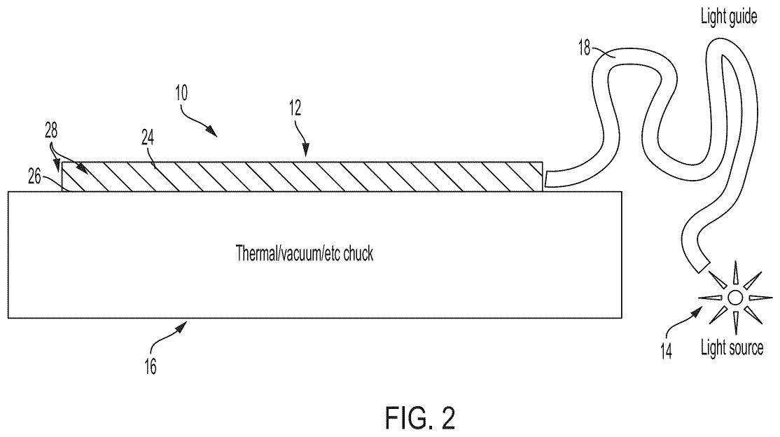

In some embodiments, the sample carrier device (e.g., a cassette) can be configured to receive a sample. In some embodiments, the sample carrier device can include one or more microfluidic channels, e.g., sample chambers or microfluidic channels etched into a planar substrate or chambers within a flow cell or microfluidic device. For example, as shown in FIG. 2, system 10 includes sample carrier device 12, thermal control module 16, and light source 14.

A sample carrier device for the systems disclosed herein can include, but is not limited to, a substrate configured to receive a sample, a microscope slide and/or an adapter configured to mount microscope slides (with or without coverslips) on a microscope stage or automated stage (e.g., an automated translation or rotational stage), a substrate, and/or an adapter configured to mount slides on a microscope stage or automated stage, a substrate comprising etched sample containment chambers (e.g., chambers open to the environment) and/or an adapter configured to mount such substrates on a microscope stage or automated stage, a flow cell and/or an adapter configured to mount flow cells on a microscope stage or automated stage, or a microfluidic device and/or an adapter configured to mount microfluidic devices on a microscope stage or automated stage. In some embodiments, the sample carrier device further includes a cassette configured to secure a substrate (e.g., a glass slide). In some embodiments, the cassette includes two or more components (e.g., a top half and a bottom half) into which the substrate is secured.

In some instances, the one or more sample carrier devices can be designed for performing a variety of chemical analysis, biochemical analysis, nucleic acid analysis, cell analysis, or tissue analysis applications. In some instances, for example, the sample carrier device (e.g., flow cells and microfluidic devices) may comprise a sample, e.g., a tissue sample. In some instances, the sample carrier device (e.g., flow cells and microfluidic devices) may comprise a sample, e.g., a tissue sample, placed in contact with, e.g., a substrate (e.g., a surface of the flow cell or microfluidic device).

The sample carrier devices for the disclosed systems (e.g., microscope slides, substrates comprising one or more etched microfluidic channel, flow cells or microfluidic devices comprising one or more microfluidic channels, etc.) can be fabricated from any of a variety of materials known to those of skill in the art including, but not limited to, glass (e.g., borosilicate glass, soda lime glass, etc.), fused silica (quartz), silicon, polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET), polydimethylsiloxane (PDMS), etc.), polyetherimide (PEI) and perfluoroelastomer (FFKM) as more chemically inert alternatives, or any combination thereof. FFKM is also known as Kalrez.

The one or more materials used to fabricate sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be optically transparent to facilitate use with spectroscopic or imaging-based detection techniques. In some instances, the entire sample carrier device can be optically transparent. Alternatively, in some instances, only a portion of the sample carrier device (e.g., an optically transparent “window”) can be optically transparent.

The sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be fabricated using any of a variety of techniques known to those of skill in the art, where the choice of fabrication technique is often dependent on the choice of material used, and vice versa. Examples of suitable sample carrier device fabrication techniques include, but are not limited to, extrusion, drawing, precision computer numerical control (CNC) machining and boring, laser photoablation, photolithography in combination with wet chemical etching, deep reactive ion etching (DRIE), micro-molding, embossing, 3D-printing, thermal bonding, adhesive bonding, anodic bonding, and the like (see, e.g., Gale, et al. (2018), “A Review of Current Methods in Microfluidic Device Fabrication and Future Commercialization Prospects”, Inventions 3, 60, 1-25, which is hereby incorporated by reference in its entirety).

In some embodiments, the system can include a sample carrier device with one or more microfluidic channels or sample chambers that form a flow cell that includes fluid inlets and outlets. The flow cell can be an open flow cell wherein the microfluidic channel is open to and/or accessible from the surrounding environment. For example, FIG. 2 depicts a side view of a microfluidic system with an open flow cell, according to some embodiments disclosed herein. As shown in FIG. 2, system 10 includes substrate 12 with top surface 24, a bottom surface 26, and/or a plurality of sides 28, with no other substrate or sample carrier device located above top surface 24. According to the example in FIG. 2, substrate 12 can have at least one microfluidic channel (not shown in FIG. 2) etched on top surface 24 of substrate 12, such that the microfluidic channel is open to the surrounding environment. In some embodiments, the microfluidic channel can extend across the entire length or width of the top surface of the sample carrier device or may extend across only a portion of the top surface. In some embodiments, substrate 12 does not include any microfluidic channels.

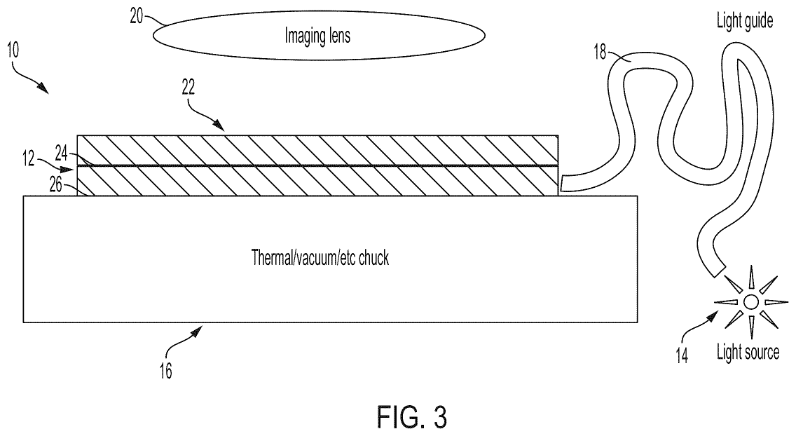

In some embodiments, the flow cell can be a closed flow cell, wherein the microfluidic channel is not open to the surrounding environment. For example, FIG. 3 depicts a side view of a system with a closed flow cell, in accordance with some embodiments disclosed herein. As shown in FIG. 3, system 10 includes substrate 12 connected to second substrate 22 along top surface 24 of substrate 12. According to the example in FIG. 3, at least one microfluidic channel (not shown in FIG. 3) can be formed between top surface 24 of substrate 12 and second substrate 22, such that the microfluidic channel is not open to the surrounding environment.

For sample carrier devices comprising microfluidic channels, the dimensions of the microfluidic channels may range from about 0.1 μm to about 10 cm in length, width, and/or height (depth). In some instances, the length, width, and/or height (depth) of the microfluidic channels may be at least 0.1 μm, at least 0.5 μm, at least 1 μm, at least 5 μm, at least 10 μm, at least 50 μm, at least 100 μm, at least 500 μm, at least 1 mm, at least 5 mm, at least 1 cm, at least 5 cm, or at least 10 cm. In some instances, the length, width, and/or height (depth) of the microfluidic channels may be at most 0.1 μm, at most 0.5 μm, at most 1 μm, at most 5 μm, at most 10 μm, at most 50 μm, at most 100 μm, at most 500 μm, at most 1 mm, at most 5 mm, at most 1 cm, at most 5 cm, or at most 10 cm. Those of skill in the art will recognize that, in some instances, the length, width, and/or height (depth) of the microfluidic channels may have any value within this range, e.g., about 125 μm.

For sample carrier devices comprising microfluidic channels, e.g., microfluidic channels or sample chambers etched into a planar substrate or chambers within a flow cell or microfluidic device, the volume of the microfluidic channels may range from about 1 nL to about 1 mL. In some instances, the volume of the microfluidic channels may be at least 1 nL, at least 5 nL, at least 10 nL, at least 50 nL, at least 100 nL, at least 500 nL, at least 1 μL, at least 5 μL, at least 10 μL, at least 50 μL, at least 100 μL, at least 500 μL, at least 1 mL. In some instances, the volume of the microfluidic channels may be at most 1 nL, at most 5 nL, at most 10 nL, at most 50 nL, at most 100 nL, at most 500 nL, at most 1 μL, at most 5 μL, at most 10 μL, at most 50 μL, at most 100 μL, at most 500 μL, at most 1 mL. Those of skill in the art will recognize that, in some instances, the volume of the microfluidic channels may have any value within this range, e.g., about 1.3 μL.

In some embodiments, the system can include one or more thermal control modules (i.e., thermoelectric modules). A thermal control module for use in assemblies and systems disclosed herein can be in contact with (e.g., connected to) a surface of side of the sample carrier device. In some embodiments, the thermal control module(s) can be connected to the bottom surface of the sample carrier device and can be configured to maintain a specified temperature within one or more sample carrier devices for the purpose of facilitating the accuracy and reproducibility of assay or analysis results. Examples of thermal control modules that can be incorporated with sample carrier devices and/or the system can include, but are not limited to, resistive heating elements, infrared light sources, Peltier heating or cooling devices, heat sinks, thermistors, thermocouples, a thermal and/or vacuum chuck, and the like.

In some instances, the thermal control module can provide for a programmable temperature change at a specified, adjustable time prior to performing specific assay or analysis steps. In some instances, the thermal control module can provide for programmable changes in temperature over specified time intervals. In some instances, the thermal control module can further provide for cycling of temperatures between two or more set temperatures with specified frequency and ramp rates so that thermal cycling, e.g., for performing nucleic acid amplification reactions, may be performed.

In some instances, the thermal control module can be configured to maintain constant temperatures, to implement step changes in temperature, or to implement changes in temperature at a specified ramp rate over a temperature range between about 10° C. and about 95° C. In some instances, for example, the temperature within a sample carrier device (or other substrate disclosed herein such as the optically transparent substrate explained below) can be held constant at a specified temperature of 10° C., 15° C., 20° C., 25° C., 30° C., 35° C., 40° C., 45° C., 50° C., 55° C., 60° C., 65° C., 70° C., 75° C., 80° C., 85° C., 90° C., or 95° C. (or at any temperature within this range). In some instances, the temperature within a sample carrier device (or other substrate disclosed herein such as the optically transparent substrate explained below) may be held constant at a specified temperature to within ±0.1° C., ±0.25° C., ±0.5° C., ±1° C., ±2.5° C., or ±5° C. (or at any tolerance within this range). In some instances, the temperature within a sample carrier device (or other substrate disclosed herein such as the optically transparent substrate explained below) can be ramped at a rate of 0.1° C./s, 0.5° C./s, 1° C./s, 5° C./s, 10° C./s, 50° C./s, 100° C./s, 500° C./s, or 1000° C./s (or at any temperature ramp rate within this range) (see, e.g., Miralles, et al. (2013), “A Review of Heating and Temperature Control in Microfluidic Systems: Techniques and Applications”, Diagnostics 3:33-67, which is hereby incorporated by reference in its entirety, which is hereby incorporated by reference in its entirety).

As shown in FIG. 2, system 10 includes thermal control module 16 which is connected to bottom surface 26 of a substrate 12 such that the thermal control module 16 can control the temperature of the substrate 12. As shown in FIG. 2, the thermal control module can be a thermal and/or vacuum chuck.

In some embodiments, the system can include one or more light sources. Examples of light sources include, but are not limited to, tungsten lamps, tungsten-halogen lamps, arc lamps, lasers, light emitting diodes (LEDs), laser diodes, a Red-Green-Blue light source, or a white light source. In some embodiments, the at least one light source includes a substantially uniform spectrum. In some embodiments, the LEDs can be high CRI value LEDs (e.g., high CRI value white light LEDs). In some embodiments, the CRI value can be at least 80, at least 85, at least 90, at least 95, at least 96, at least 97, at least 98, at least 99, or 100. In some instances, the one or more light sources can produce continuous wave, pulsed, Q-switched, chirped, frequency-modulated, and/or amplitude-modulated light at a specified wavelength (or within a specified wavelength bandpass) defined by the light source alone or in combination with one or more optical filters (e.g., one or more colored glass filters, narrowband interference filters, broadband interference filters, dichroic reflectors, diffraction gratings, etc.).

In some embodiments, the system is free from any dichroic filters. For example, the system can include a Red-Green-Blue light source that enables selection of the color injected into the sample carrier device and thus enables selection of the color that transilluminates the sample carrier device without relying on a dichroic filter.

In some embodiments, the light source can be connected to the sample carrier device at one of the plurality of sides of the sample carrier device such that the light source is configured to illuminate the sample carrier device. In some embodiments, the light source can be configured to transilluminate the sample carrier device, wherein the sample carrier device is illuminated via the transmission of light through the sample carrier device. For example, FIGS. 3A and 3B depict a top view of substrate 12 connected to a plurality of light guides 18 and transilluminated by light source 14. In some embodiments, the side furthest from the imaging lens acts as the illumination device.

In some instances, a system can include a light source located beneath a sample carrier device that illuminates the sample carrier device through illumination holes cut into the bottom surface of the sample carrier device. According to some embodiments disclosed herein, the sample carrier device is free from any illumination holes. For example, as illustrated in FIG. 2, system 10 includes substrate 12 which is free of any illumination holes configured such that thermal control module 16 is in constant contact with bottom surface 26 of substrate 12. Beneficially, such configuration may not reduce the amount of surface area of the sample carrier device contacting the thermal control module 16 and thus may not impact the temperature control or uniformity of the sample carrier device. In some embodiments, the microfluidic device is designed such that the side furthest from the imaging lens acts as the illumination device.

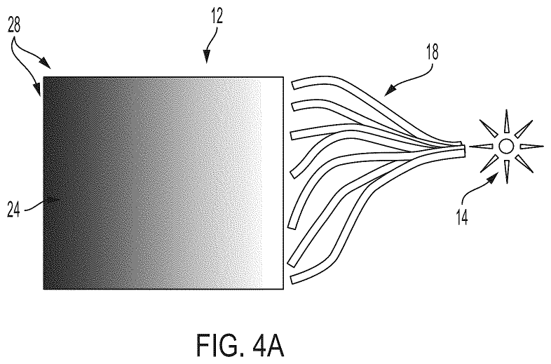

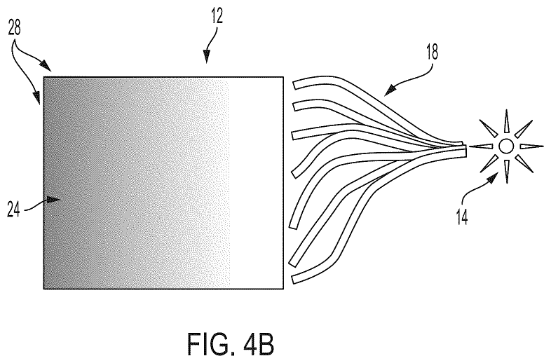

According to some embodiments, the system can include one or more light sources that are connected to the sample carrier device via at least one light guide, or via a plurality of light guides, in non-limiting examples. In some embodiments, the light guide or plurality of light guides can be connected to the sample carrier device along only one side of the sample carrier device such that the sample carrier device is illuminated by light from only one side. For example, FIG. 4A depicts a top view of substrate 12 connected to a plurality of light guides 18, in accordance with some embodiments. As shown in FIG. 4A, substrate 12 is connected to a single light source 14 at various points along only one side 28 of the plurality of sides of substrate 12.

In embodiments wherein the system includes a plurality of light guides, the plurality of light guides can be connected to the sample carrier device at various points along one or multiple sides of the sample carrier device, such that the sample carrier device is transilluminated by light from one or more sides. In embodiments wherein the system includes a plurality of light guides, the plurality of light guides can be connected to an optically transparent substrate (e.g., sapphire glass pad) at various points along one or multiple sides of the optically transparent substrate, such that the optically transparent substrate is transilluminated by light from one or more sides. In some embodiments, the plurality of light guides may comprise a fiber bundle.

In some embodiments, the system can include one or more light sources that are directly connected to a sample carrier device. In a non-limiting example, the system can include a plurality of light sources that are directly connected to a sample carrier device via at least one light guide.

In some embodiments, the system can include one or more light sources that are bonded to the sample carrier device. In non-limiting examples, the system can include a single light source that is bonded to a sample carrier device or that is bonded to a sample carrier device via at least one light guide.

In some embodiments, the system can include a light source connected to a sample carrier device that does not include diffusers in/on the sample carrier device. In such system, the light injected into the sample carrier device will generally be confined within an area of the sample carrier device by total internal reflection, as shown in FIG. 4A.

In some embodiments, the system can include a light source connected to a sample carrier device with one or more diffusers configured to diffuse or scatter light from a light source. In such system, the light injected into the sample carrier device will be diffused further throughout the sample carrier device, as shown in FIG. 4B. Beneficially, diffusing the light injected into the sample carrier device over a larger portion of the sample carrier device may improve transillumination through the sample carrier device.

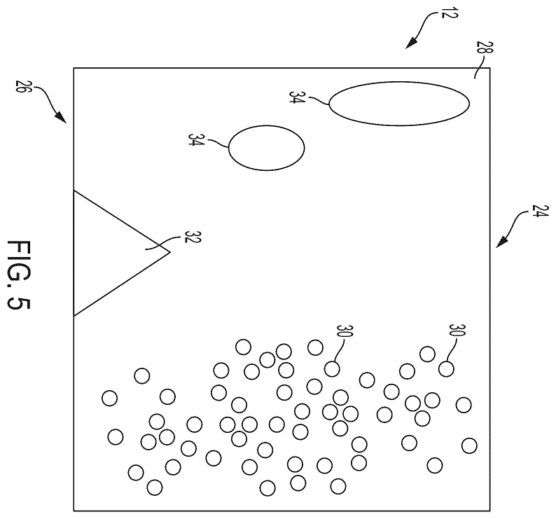

FIG. 5 depicts a sample carrier device that includes a plurality of diffusers, in accordance with some embodiments. The diffusers can comprise small diffusive elements, surface based diffusive elements, and/or laser marked diffusive elements, in non-limiting examples. The plurality of diffusers can be located inside of the sample carrier device, on the top surface of the sample carrier device, on the bottom surface of the sample carrier device, on one or more of the plurality of sides of the sample carrier device, or any combination of the above locations. For example, as shown in FIG. 5, substrate 12 contains small diffusive elements 30 and laser marked diffusive elements 34 located inside substrate 12 and one surface based diffusive element 32 located on bottom surface 26 of substrate 12. Beneficially, locating diffusers inside of the sample carrier device may not reduce the surface area of any of the bottom, top, or side surface of the sample carrier device and therefore may not decrease the surface area available for connecting the sample carrier device to a thermal control module or light source, or the surface area available for a microfluidic channel located on a top surface of the sample carrier device.

The one or more diffusers for the disclosed system can be fabricated using various processes. A surface based diffusive element may be fabricated via laser-based processes, chemical processes such as chemical etching with or without lithography, or mechanical processes such as sandblasting or injection molding. Laser marked diffusive elements may be fabricated via laser marking. Small diffusive elements may be fabricated relying on material engineering or laser processing.

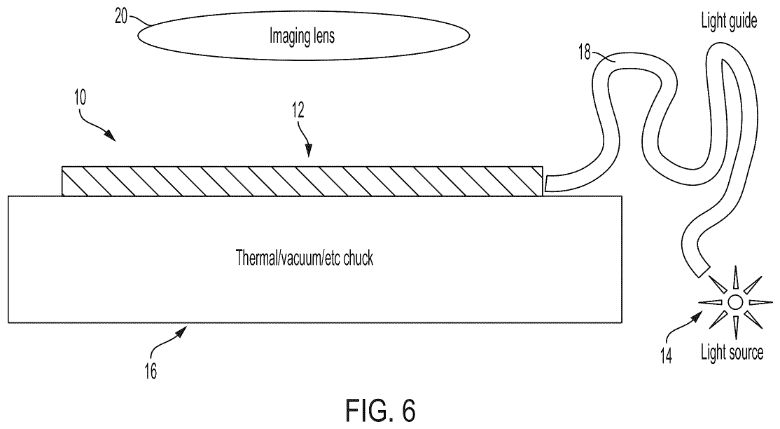

According to some embodiments, the system can include a sample carrier device with at least one microfluidic channel forming an open flow cell and an imaging device configured to capture an image of the at least one microfluidic channel. For example, FIG. 6 depicts a side view of system 10 including imaging device 20 positioned above substrate 12 with a microfluidic channel forming an open flow cell such that imaging device 20 can capture an image of the microfluidic channel (not shown) located on the top surface of substrate 12. In some embodiments, the imaging device includes an objective lens. In some embodiments, the objective lens has a high numerical aperture. In some embodiments, the objective lens has a numerical aperture of less than about 1.0. In some embodiments, the objective lens has a numerical aperture of less than or equal to about 0.90. In some embodiments, the objective lens has a numerical aperture of greater than or equal to about 1.0. In some embodiments, the objective lens has a numerical aperture of about 1 to about 1.4.

According to some embodiments, the system can include a sample carrier device with at least one microfluidic channel forming a closed flow cell and an imaging device. For example, as shown in FIG. 3, system 10 includes imaging device 20 located above second substrate 22 thereby located on a side of second substrate 22 that is opposite substrate 12.

In some instances, the system disclosed herein can include an imaging device with a commercial optical imaging instrument for detection and readout, e.g., a commercial fluorescence microscope or a fluorescence imaging microplate reader. Examples of suitable fluorescence microscopes include, but are not limited to, the Zeiss Axioscope 5 multichannel fluorescence microscope (Carl Zeiss Microscopy, LLC, White Plains, N), the Olympus BX63 automated fluorescence microscope (Olympus Scientific Solutions Americas Corp., Waltham, MA), and the Nikon Eclipse Ti2 fluorescence microscope (Nikon Instruments, Inc., Melville, NY). Examples of fluorescence imaging microplate readers include, but are not limited to, the Tecan Spark® Cyto multimode microplate reader (Tecan SP, Inc., Baldwin Park, CA) and the Molecular Devices SpectraMax i3x multimode microplate reader (Molecular Devices, San Jose, CA).

In some instances, the system disclosed herein can include an imaging device with a custom optical imaging instrument for detection and readout, e.g., a custom fluorescence imaging module (or fluorescence imaging unit), which may comprise one or more light sources, one or more objective lenses, one or more sample carriers (e.g., sample holders, sample stages, and/or translation stages), one or more tube lenses, one or more image sensors or cameras, one or more processors or controllers, one or more additional optical components (e.g., lenses, mirrors, prisms, beam-splitters, optical filters, colored glass filters, narrowband interference filters, broadband interference filters, dichroic reflectors, diffraction gratings, apertures, shutters, optical fibers, optical waveguides, acousto-optic modulators, and the like), or any combination thereof. In some instances, the custom imaging module may comprise a focus mechanism, e.g., an autofocus mechanism. In some instances, the custom imaging module may be configured to perform multichannel imaging, e.g., multichannel fluorescence imaging comprising the use of excitation light at one or more excitation wavelengths, and imaging the emitted fluorescence at two or more different emission wavelengths.

In some instances, the system can include an imaging device configured to acquire images in any of a variety of imaging modes. Examples include, but are not limited to, bright-field, dark-field, fluorescence, phase contrast, or differential interference contrast (DIC), and the like, where the combination of magnification and contrast mechanism provides images having cellular or sub-cellular image resolution. In some instances, the imaging device can be configured to perform wide-field microscopic imaging (see, e.g., Combs, et al. (2017), “Fluorescence Microscopy: A Concise Guide to Current Imaging Methods”, Current Protocols in Neuroscience 79, 2.1.1-2.1.25, which is hereby incorporated by reference in its entirety). In some instances, the imaging device can be configured to perform volumetric imaging (or optical sectioning) using camera-based approaches (e.g., scanned focus imaging, multi-focus imaging, extended focus imaging, etc.) or scanning-based approaches (e.g., fast three-dimensional scanning) (see, e.g., Mertz (2019), “Strategies for Volumetric Imaging with a Fluorescence Microscope”, Optica 6(10):1261-1268, which is hereby incorporated by reference in its entirety). In some instances, the optical imaging device can be configured to perform optical sectioning using light sheet microscopy (see, e.g., Combs, et al. (2017), ibid.; Power, et al. (2017), “A Guide to Light-Sheet Fluorescence Microscopy for Multiscale Imaging”, Nature Methods 14(4):360-373, which is hereby incorporated by reference in its entirety).

In some instances, the system can include an imaging device that can be configured to perform wide-field microscopic imaging (e.g., epi-fluorescence microscopic imaging). Used in combination with large format cameras having high sensitivity, high dynamic range, low noise characteristics, and fast frame rates, wide-field microscopy enables fast image acquisition and good contrast at low signal levels while offering diffraction-limited (or near-diffraction-limited) spatial (lateral) resolution over large fields of view. (Combs, et al. (2017), ibid).

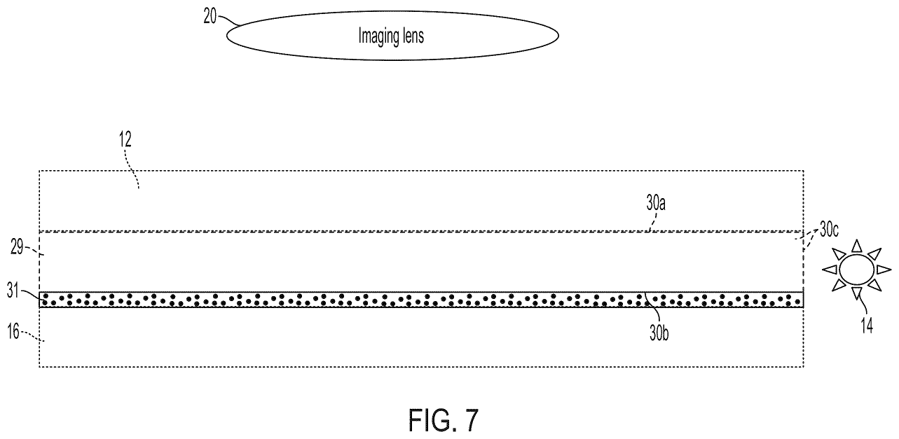

In some instances, the systems disclosed herein can include an optically transparent substrate. For example, FIG. 7 illustrates a system with an optically transparent substrate 29 on a side of the sample carrier device 12 (e.g., sample substrate configured to receive a sample). The optically transparent substrate can be fabricated from any of a variety of materials known to those of skill in the art including, but not limited to, sapphire glass, glass (e.g., borosilicate glass, soda lime glass, etc.), fused silica (quartz), polymer (e.g., polycarbonate (PC), polyethylene (PE), high density polyethylene (HDPE), polyethylene terephthalate (PET), polydimethylsiloxane (PDMS), etc.), or any combination thereof. In various embodiments, an optically transparent material is selected to provide high thermal conductivity between the optically transparent substrate (e.g., sapphire glass) and the sample substrate (e.g., glass microscope slide).

The one or more materials used to fabricate optically transparent substrate for the disclosed systems can be optically transparent to facilitate use with spectroscopic or imaging-based detection techniques. In some instances, the entire optically transparent substrate can be optically transparent. Alternatively, in some instances, only a portion of the optically transparent substrate (e.g., an optically transparent “window”) can be optically transparent. In some embodiments, the optically transparent substrate exhibits good thermal conductivity.

The optically transparent substrate for the disclosed systems can be fabricated using any of a variety of techniques known to those of skill in the art, where the choice of fabrication technique is often dependent on the choice of material used, and vice versa. Examples of suitable optically transparent fabrication techniques include, but are not limited to, extrusion, drawing, precision computer numerical control (CNC) machining and boring, laser photoablation, photolithography in combination with wet chemical etching, deep reactive ion etching (DRIE), micro-molding, embossing, 3D-printing, thermal bonding, adhesive bonding, anodic bonding, and the like (see, e.g., Gale, et al. (2018), “A Review of Current Methods in Microfluidic Device Fabrication and Future Commercialization Prospects”, Inventions 3, 60, 1-25, which is hereby incorporated by reference in its entirety, which is hereby incorporated by reference in its entirety).

The optically transparent substrate can include a top surface 30a, a bottom surface 30b, and a plurality of sides 30c. In some embodiments, a top surface of the optically transparent substrate is on a side of the sample substrate opposite the sample receiving surface of the sample substrate. In some embodiments, a top surface of the optically transparent surface is connected to a bottom surface of a sample substrate. In some embodiments, the sample substrate contacts the top surface of the optically transparent substrate.

In some embodiments, at least one light source can be configured to illuminate at least one of the plurality of sides of the optically transparent substrate. In some embodiments, the at least one light source is connected to the at least one of the plurality of sides of the optically transparent substrate that it illuminates similarly to those ways the light source can be connected to sample carrier device disclosed herein. In some embodiments, the at least one light source is not connected to the at least one of the plurality of sides of the optically transparent substrate that it illuminates. For example, the light source can be spaced away or apart from the at least one side of the optically transparent substrate. In some embodiments, a system can include at least one light source located beneath the optically transparent substrate such that it illuminates the sample substrate from the bottom through the optically transparent substrate. In some embodiments, the at least one light source is positioned in a plane that is substantially aligned with at least one side of the plurality of sides of the optically transparent substrate (or sample substrate). In some embodiments, the at least one light source can be configured such that light emitted from the at least one light source is perpendicular to the at least one side of the plurality of sides of the optically transparent substrate (or sample substrate). In some embodiments, a method of using the assembly can include energizing the at least one light source to thereby couple emitted light from the at least one light source to the optically transparent substrate (and scatter the emitted light via the light scattering layer to transilluminate the sample).

In some embodiments, the light source can be connected to the optically transparent substrate at one of the plurality of sides of the optically transparent substrate such that the light source is configured to illuminate the optically transparent substrate. In some embodiments, the light source can be configured to transilluminate the optically transparent substrate, wherein the optically transparent substrate is illuminated via the transmission of light through the optically transparent substrate. In some embodiments, light emitted from the at least one light source can be coupled by the second substrate and converted to wide angle transillumination of the sample.

According to some embodiments, the system can include one or more light sources that are connected to the optically transparent substrate via at least one light guide, or via a plurality of light guides, in non-limiting examples. In some embodiments, the light guide provides monolithic transillumination by directly coupling the light source(s) to an optically transparent substrate (e.g., glass slide, sapphire glass pad, etc.). In some embodiments, the light guide or plurality of light guides can be connected to the optically transparent substrate along only one side of the optically transparent substrate such that the optically transparent substrate is illuminated by light from only one side.

In embodiments wherein the system includes a plurality of light guides, the plurality of light guides can be connected to the optically transparent substrate at various points along one or multiple sides of the optically transparent substrate, such that the optically transparent substrate is transilluminated by light from one or more sides. In some embodiments, the plurality of light guides may comprise a fiber bundle. In some embodiments, the system/assembly can include a fiber optic device that can couple light from or the at least one light source to the optically transparent substrate, light scattering layer, and/or sample substrate.

In some embodiments, the system can include one or more light sources that are directly connected to an optically transparent substrate. In a non-limiting example, the system can include a optically transparent substrate that are directly connected to a optically transparent substrate via at least one light guide.

In some embodiments, the system can include one or more light sources that are bonded to the optically transparent substrate. In non-limiting examples, the system can include a single light source that is bonded to an optically transparent substrate or that is bonded to a optically transparent substrate via at least one light guide.

In some embodiments, the system can include a plurality of light sources configure to illuminate more than one or all sides of the optically transparent substrate such that the light sources illuminate the optically transparent substrate by light from one or more sides. In some embodiments, the light source or plurality of light sources may not be configured to illuminate all the sides of the optically transparent substrate. In some embodiments, the side(s) of the optically transparent substrate that is not illuminated by the light source(s) can comprise a reflective layer. In some embodiments, at least one reflective layer can be disposed on at least one of the plurality of sides of the optically transparent substrate (or sample substrate). The reflective layer can be configured to reflect light back into the optically transparent substrate (or sample substrate). In other words, as light from the light source enters at least one side of the optically transparent substrate, the light can travel through the optically transparent substrate and out another side of the optically transparent substrate. A reflective layer on a side of the optically transparent substrate can reflect the light back into the area of the optically transparent substrate instead of it leaving through that side. In some embodiments, a reflective layer can be a uniform reflective layer such that it covers the entire side of the optically transparent substrate. In some embodiments, a reflective layer can cover a portion of the entire side of the optically transparent substrate such that some of the light can exit that side of the optically transparent substrate. In some embodiments, the reflective layer can be sputtered onto one or more sides of the optically transparent substrate. In some embodiments, the reflective layer is disposed or applied (e.g., painted, screened, patterned, etc.) onto one or more sides of the optically transparent substrate. In some embodiments, a reflective layer can be on one or more sides of the optically transparent substrate opposite a side of the optically transparent substrate with a light source (i.e., the side illuminated by the at least one light source) or on one or more sides not illuminated by the at least one light source. In some embodiments, the reflective layer can include silver, aluminum, or combinations thereof. In some embodiments, the reflective layer can include other components configured to reflect light such as white light.

In some embodiments, light from the optically transparent substrate can illuminate the sample carrier device (e.g., sample substrate). In other words, light can exit the optically transparent substrate through its top surface and enter the sample carrier device in order to illuminate the sample carrier device from the bottom. In some embodiments, the optically transparent substrate is configured to uniformly illuminate the sample carrier device (e.g., sample substrate).

In some embodiments, a system can include at least one light scattering layer 31. In some embodiments, a light scattering layer can be on the top surface, the bottom surface, or on at least one of the plurality of sides of the optically transparent substrate. In some embodiments, the light scattering layer can be at least one side or the bottom surface of a sample substrate. A light scattering layer can be configured to scatter light from a light source. In some embodiments, light entering the optically transparent substrate can then travel to a light scattering layer where the light can be scattered back into the optically transparent substrate. In some embodiments, a light scattering layer can be configured to uniformly scatter light into the optically transparent substrate. In some embodiments, a light source(s) can be configured to illuminate a light scattering layer. Scattering light in the optically transparent substrate over a larger portion of the optically transparent substrate may improve transillumination through the optically transparent substrate. In turn, this may improve illumination of the sample carrier device (e.g., sample substrate).

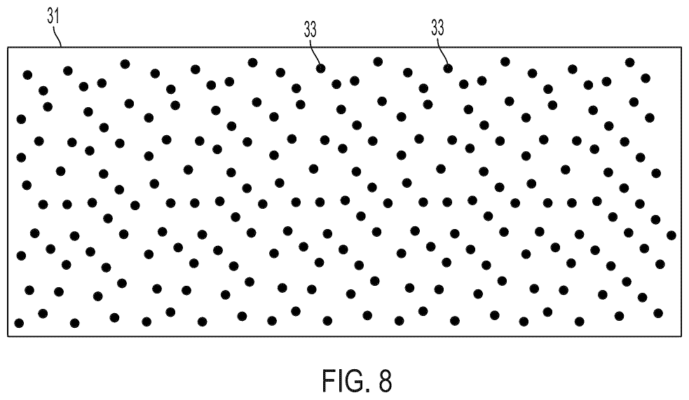

FIG. 8 depicts a light scattering layer that includes a plurality of nanoparticles 33. In some embodiments, the nanoparticles are configured to uniformly scatter light that is coupled by the optically transparent substrate to which the light scattering layer is applied and reaches the light scattering layer. In some embodiments, the nanoparticles include metallic oxide nanoparticles such as titanium dioxide (TiO₂), aluminum oxide (Al₂O₃), or combinations thereof. In some embodiments, the nanoparticles have an average diameter of less than or equal to 1 micron, less than or equal to 900 nm, less than or equal to 800 nm, less than or equal to 700 nm, less than or equal to 600 nm, less than or equal to 500 nm, less than or equal to 400 nm, less than or equal to 300 nm, or less than or equal to 200 nm. In some embodiments, the nanoparticles have an average diameter of less than or equal to 1 micron, less than or equal to 900 nm, less than or equal to 800 nm, less than or equal to 700 nm, less than or equal to 600 nm, less than or equal to 500 nm, less than or equal to 400 nm, less than or equal to 300 nm, or less than or equal to 200 nm. In some embodiments, the nanoparticles have an average diameter of more than or equal to 1 nm, more than or equal to 20 nm, more than or equal to 50 nm, more than or equal to 100 nm, more than or equal to 150 nm, or more than or equal to 200 nm.

In some embodiments, the light scattering layer can include a plurality of nanoparticles disposed within a polymer. In some embodiments, the light scattering layer can include an epoxy resin (as the polymer). In some embodiments, the epoxy resin provides a curable matrix configured to hold the nanoparticles in place in the light scattering layer (once cured). In some embodiments, a light scattering layer includes about 10-90 wt. % nanoparticles, about 10-80 wt. % nanoparticles, about 10-70 wt. % nanoparticles, about 10-60 wt. % nanoparticles, about 10-50 wt. % nanoparticles, about 10-40 wt. % nanoparticles, about 10-30 wt. % nanoparticles, about 10-20 wt. % nanoparticles, about 20-90 wt. % nanoparticles, about 20-80 wt. % nanoparticles, about 20-70 wt. % nanoparticles, about 20-60 wt. % nanoparticles, about 20-50 wt. % nanoparticles, about 20-40 wt. % nanoparticles, about 20-30 wt. % nanoparticles, about 30-90 wt. % nanoparticles, about 30-80 wt. % nanoparticles, about 30-70 wt. % nanoparticles, about 30-60 wt. % nanoparticles, about 30-50 wt. % nanoparticles, about 30-40 wt. % nanoparticles, about 40-90 wt. % nanoparticles, about 40-80 wt. % nanoparticles, about 40-70 wt. % nanoparticles, about 40-60 wt. % nanoparticles, about 40-50 wt. % nanoparticles, about 50-90 wt. % nanoparticles, about 50-80 wt. % nanoparticles, about 50-70 wt. % nanoparticles, or about 50-60 wt. % nanoparticles. In some embodiments, the light scattering layer can be formed on a surface and/or side of any substrate disclosed herein. In some embodiments, the light scattering layer coats a surface and/or side of any substrate disclosed herein and the solvent in the light scattering layer dissolves such that a layer of nanoparticles remains on the substrate. In some embodiments, a light scattering layer can be formed using solvent-based silver conductive screen printing ink. In some embodiments, a light scattering layer can be a standalone layer that is connected to a side and/or surface of any substrate disclosed herein.

In various embodiments, the system can include one or more thermal control modules (i.e., thermoelectric modules). In some embodiments, a thermal control module can be positioned on a side and/or surface of the optically transparent substrate. In some embodiments, a thermal control module can be coupled to the optically transparent substrate and configured to control the temperature of the substrate. In some embodiments, a thermal control module can contact the light scattering layer opposite the second substrate. In some embodiments, a thermal control module can be on a side of the light scattering layer opposite the optically transparent substrate. In some embodiments, a thermal control module can be configured to control the temperature of the optically transparent substrate and/or sample carrier device. In some embodiments, a thermal control module can control the temperature of the optically transparent substrate (which can have good thermal conductivity) and the optically transparent substrate can transfer heat and/or cold to the sample carrier device (e.g., sample substrate). In some embodiments, a thermal control module can be connected to a light scattering layer that is connected to a bottom surface of an optically transparent substrate as shown in FIG. 7. In some embodiments, a thermal control module can be configured to maintain a specified temperature within one or more of the optically transparent substrate and the sample carrier device for the purpose of facilitating the accuracy and reproducibility of assay or analysis results. Examples of thermal control modules, their programmability, and their maintainable temperature ranges were discussed above.

As explained above, the system disclosed herein can include an imaging device. The imaging device can be configured to capture an image of a sample. In some embodiments, the imaging device is on a side of the sample carrier device (e.g., sample substrate) opposite the optically transparent substrate.

As explained above, the system can include an imaging device configured to acquire images in any of a variety of imaging modes. For example, in some embodiments, a light source may be configured to illuminate at least one side of a sample substrate for imaging in one mode and a second light source can be configured to illuminate at least one side of the optically transparent substrate (which thereby illuminates the sample substrate) for imaging in a second mode. As explained above, examples of imaging modes include, but are not limited to, bright-field, dark-field, fluorescence, phase contrast, or differential interference contrast (DIC), and the like, where the combination of magnification and contrast mechanism provides images having cellular or sub-cellular image resolution. In some instances, the imaging device can be configured to perform wide-field microscopic imaging (see, e.g., Combs, et al. (2017), “Fluorescence Microscopy: A Concise Guide to Current Imaging Methods”, Current Protocols in Neuroscience 79, 2.1.1-2.1.25, which is hereby incorporated by reference in its entirety). In some instances, the imaging device can be configured to perform volumetric imaging (or optical sectioning) using camera-based approaches (e.g., scanned focus imaging, multi-focus imaging, extended focus imaging, etc.) or scanning-based approaches (e.g., fast three-dimensional scanning) (see, e.g., Mertz (2019), “Strategies for Volumetric Imaging with a Fluorescence Microscope”, Optica 6(10):1261-1268, which is hereby incorporated by reference in its entirety). In some instances, the optical imaging device can be configured to perform optical sectioning using light sheet microscopy (see, e.g., Combs, et al. (2017), ibid.; Power, et al. (2017), “A Guide to Light-Sheet Fluorescence Microscopy for Multiscale Imaging”, Nature Methods 14(4):360-373, which is hereby incorporated by reference in its entirety). In some instances, the system can include an imaging device that can be configured to perform wide-field microscopic imaging (e.g., epi-fluorescence microscopic imaging). Used in combination with large format cameras having high sensitivity, high dynamic range, low noise characteristics, and fast frame rates, wide-field microscopy enables fast image acquisition and good contrast at low signal levels while offering diffraction-limited (or near-diffraction-limited) spatial (lateral) resolution over large fields of view. (Combs, et al. (2017), ibid).

In some instances, the system can comprise one or more commercial imaging instruments, one or more custom imaging devices, one or more additional processors or controllers (e.g., computers or computer systems), one or more sample carriers, one or more fluidics modules, one or more temperature control modules (i.e., heat exchangers), one or more motion control modules (which may comprise one or more translation and/or rotation stages), one or more system control software packages, one or more data analysis (e.g., image processing) software packages, or any combination thereof. In some instances, the system may comprise an integrated system, e.g., where the different functional subsystems are mounted on a single framework or chassis, and packaged within a single housing. In some instances, the system may comprise a modular system, e.g., where the different functional subsystems are mounted on separate frameworks or chassis, and packaged in separate housings.

In some instances, the system can comprise one or more system control modules (or system controllers) configured to synchronize and control data communication between other functional units of the system, e.g., the one or more imaging devices, one or more fluidics modules, one or more temperature control modules (i.e., heat exchangers), one or more motion control modules, or any combination thereof. In some instances, a system control module may comprise one or more processors, one or more power supplies, one or more wired and/or wireless data communication interfaces, one or more memory storage devices, one or more user interface devices (e.g., keyboards, mice, displays, etc.), or any combination thereof. In some instances, the system control function may be provided by an external computer or computer system. In some instances, the one or more system control modules may interface with one or more external computers or computer systems.

For the purpose of clarity and a concise description, features are described herein as part of the same or separate embodiments; however, it will be appreciated that the scope of the disclosure includes embodiments having combinations of all or some of the features described.

### Additional Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein.

1. An assembly comprising:
a first substrate configured to receive a biological sample, wherein the first substrate is optically transparent;
a second substrate having a top surface, a bottom surface, and a plurality of sides, wherein the first substrate contacts the top surface of the second substrate, wherein the second substrate is optically transparent;
at least one light source configured to illuminate at least one of the plurality of sides of the second substrate;
a light scattering layer on the bottom surface of the second substrate, wherein the light scattering layer is configured to scatter light from the light source; and
a thermal control module coupled to the second substrate and configured to control the temperature of the second substrate.

2. The assembly of claim 1, wherein the light scattering layer comprises a plurality of titanium dioxide nanoparticles disposed within a polymer.

3. The assembly of claim 2, wherein the plurality of titanium dioxide nanoparticles comprises a mean diameter of less than or equal to about 500 nm.

4. The assembly of any one of claims 2-3, wherein the plurality of titanium nanoparticles is 30-60 wt. % of the light scattering layer.

5. The assembly of any one of claims 2-4, wherein the polymer comprises an epoxy resin.

6. The assembly of any one of claims 1-5, wherein the second substrate comprises sapphire glass.

7. The assembly of any one of claims 1-6, further comprising at least one reflective layer disposed on at least one of the plurality of sides of the second substrate.

8. The assembly of claim 7, wherein the at least one reflective layer comprises silver or aluminum.

9. The assembly of any one of claims 7-8, wherein the at least one reflective layer is disposed on at least one of the plurality of sides that is not illuminated by the at least one light source.

10. The assembly of any one of claims 7-9, wherein each reflective layer is opposite a side of the second substrate illuminated by the at least one light source.

11. The assembly of any one of claims 1-10, wherein the at least one light source is connected to at least one of the plurality of sides of the second substrate.

12. The assembly of any one of claims 1-11, wherein light emitted from the at least one light source is coupled by the second substrate and converted to wide angle transillumination of the sample.

13. The assembly of claim 12, wherein the at least one light source comprises light emitting diodes (LEDs).

14. The assembly of claim 13, wherein the at least one light source comprises a substantially uniform spectrum.

15. The assembly of any one of claims 1-14, wherein the at least one light source is positioned in a plane that is substantially aligned with at least one side of the plurality of sides.

16. The assembly of any one of claims 1-15, further comprising a fiber optic device coupling the at least one light source to the second substrate and/or the light scattering layer.

17. The assembly of any one of claims 1-16, wherein the thermal control module contacts the light scattering layer opposite the second substrate.

18. A system comprising:
the assembly of any one of claims 1-17; and
an imaging device configured to capture an image of the sample.

19. The system of claim 18, wherein the imaging device is disposed on a side of the first substrate opposite the second substrate.

20. The system of claim 18 or claim 19, wherein the imaging device comprises an objective lens.

21. The system of claim 20, wherein the objective lens comprises a high numerical aperture.

22. The system of claim 21, wherein the objective lens comprises a numerical aperture of about 1.0 or more.

23. The system of any one of claims 1-22, wherein the sample substrate comprises a glass slide.

24. A method comprising:
providing an assembly comprising:
a first substrate configured to receive a biological sample, wherein the first substrate is optically transparent;
a second substrate having a top surface, a bottom surface, and a plurality of sides, wherein the first substrate contacts the top surface of the second substrate, wherein the second substrate is optically transparent;
at least one light source configured to illuminate at least one of the plurality of sides of the second substrate; a light scattering layer on the bottom surface of the second substrate, wherein the light scattering layer is configured to scatter light from the light source; and
energizing the at least one light source to thereby couple emitted light from the at least one light source to the second substrate and scatter the emitted light via the light scattering layer to transilluminate the sample.

25. The method of claim 24, wherein the assembly further comprises a thermal control module coupled to the second substrate and configured to control the temperature of the second substrate, wherein the thermal control module contacts the light scattering layer opposite the second substrate.

26. The method of claim 24 or claim 25, wherein the light scattering layer comprises a plurality of titanium dioxide nanoparticles disposed within a polymer.

27. The method of claim 26, wherein the plurality of titanium dioxide nanoparticles comprises a mean diameter of less than or equal to about 500 nm.

28. The method of any one of claims 26-27, wherein the plurality of titanium nanoparticles is 30-60 wt. % of the light scattering layer.

29. The method of any one of claims 26-28, wherein the polymer comprises an epoxy resin.

30. The method of any one of claims 24-29, wherein the second substrate comprises sapphire glass.

31. The method of any one of claims 24-30, further comprising at least one reflective layer disposed on at least one of the plurality of sides of the second substrate.

32. The method of claim 31, wherein the at least one reflective layer comprises silver or aluminum.

33. The method of any one of claims 31-32, wherein the at least one reflective layer is disposed on at least one of the plurality of sides that is not illuminated by the at least one light source.

34. The method of any one of claims 31-33, wherein each reflective layer is opposite a side of the second substrate illuminated by the at least one light source.

35. The method of any one of claims 24-34, wherein the at least one light source is connected to at least one of the plurality of sides of the second substrate.

36. The method of any one of claims 24-35, wherein light emitted from the at least one light source is coupled by the second substrate and converted to wide angle transillumination of the sample.

37. The method of claim 36, wherein the at least one light source comprises light emitting diodes (LEDs).

38. The method of claim 37, wherein the at least one light source comprises a substantially uniform spectrum.

39. The method of any one of claims 24-38, wherein the at least one light source is positioned in a plane that is substantially aligned with at least one side of the plurality of sides.

40. The method of any one of claims 24-39, further comprising a fiber optic device coupling the at least one light source to the second substrate and/or the light scattering layer.

41. A substrate made by the process comprising:
providing an optically transparent substrate having a top, a bottom, and a plurality of sides, wherein the optically transparent substrate comprises sapphire glass;
applying to the bottom of the optically transparent substrate a layer comprising a plurality of titanium dioxide nanoparticles and epoxy resin, wherein the plurality of titanium dioxide nanoparticles has a mean diameter of less than or equal to about 500 nm; and
applying to at least one side of the plurality of sides a silver or aluminum layer.
